(19) United States
(12) Patent Application Publication
(10) Pub. No.: US 2024/0182771 A1
(43) Pub. Date: Jun. 6, 2024

(54) POROUS NANOPARTICLE-BASED RADIATIVE COOLING MATERIAL AND RADIATIVE COOLING DEVICE USING THE SAME

(71) Applicant: UNIVERSITY-INDUSTRY COOPERATION GROUP OF KYUNG HEE UNIVERITY, Yongin-si (KR)

(72) Inventors: Sun Kyung KIM, Suwon-si (KR); Sun Ho JEONG, Yongin-si (KR); Su Jin PARK, Suwon-si (KR); Seok Beom SEO, Ansan-si (KR)

(73) Assignee: UNIVERSITY-INDUSTRY COOPERATION GROUP OF KYUNG HEE UNIVERITY, Yongin-si (KR)

(21) Appl. No.: 18/528,128

(22) Filed: Dec. 4, 2023

(30) Foreign Application Priority Data
Dec. 5, 2022 (KR) 10-2022-0167641

(51) Int. Cl. C09K 5/14; F28F 13/18

(52) U.S. Cl. CPC C09K 5/14; F28F 13/185; F28F 2245/06

(57) ABSTRACT

The present disclosure relates to a porous nanoparticle-based radiative cooling material and a radiative cooling device using the same. The porous nanoparticle-based radiative cooling material according to one embodiment of the present disclosure includes a plurality of porous nanoparticles and binder molecules, wherein the porous nanoparticles reflect incident sunlight and absorb and radiate mid-infrared light, pores are included inside dielectric particles, reflectance for the incident sunlight and mid-infrared emissivity are increased based on the pores, and a laminated structure distribution is formed by the binder molecules.

### CROSS-REFERENCE TO RELATED APPLICATION

This application claims priority to Korean Patent Application No. 10-2022-0167641, filed on Dec. 5, 2022, in the Korean Intellectual Property Office, the disclosure of which is incorporated herein by reference.

### BACKGROUND OF THE DISCLOSURE

### Field of the Disclosure

The present disclosure relates to a porous nanoparticle-based radiative cooling material and a radiative cooling device using the same. More particularly, the present disclosure relates to a porous nanoparticle-based radiative cooling material that reflects ultraviolet light, visible light, and near-infrared light in the solar wavelength band and radiates mid-infrared light in the wavelength band of the atmospheric window and a radiative cooling device formed on the surface of the porous nanoparticle-based radiative cooling material.

### Description of the Related Art

As smart mobility such as electric vehicles and unmanned aerial vehicles develops, and small smart devices such as virtual and augmented reality devices and wearable devices become popular, global heat generation is increasing significantly.

As environmental problems caused by global warming emerge, low-power, eco-friendly heat dissipation technology has become a necessity rather than an option.

Radiative cooling technology is representative power-free, eco-friendly cooling technology that does not consume additional energy.

An ideal radiative cooling material should fully reflect electromagnetic waves emitted by a heat source while acting as a black body in the wavelength band of external radiation.

Under typical outdoor environmental conditions, a material that perfectly reflects ultraviolet light-visible light-near-infrared light (wavelength: 0.3 μm to 2.5 μm) in the solar wavelength band and perfectly radiates mid-infrared light (wavelength: 2.5 μm to 25 μm) including the atmospheric window is ideal.

When a radiative cooling material is manufactured using an additive manufacturing method, the scale and curvature of an applied structure may be implemented in various ways. Additionally, law materials may be saved and manufacturing time may be reduced, thereby improving economic efficiency.

The additive manufacturing technology is core technology in the modern manufacturing industry as the additive manufacturing technology allows free modeling of various materials regardless of size and curvature.

In addition, the additive manufacturing technology meets the requirements of the eco-friendly industrial society in that the additive manufacturing technology reduces manufacturing time and waste of materials.

Solar reflectance and atmospheric window emissivity, which are key performance indicators of radiative cooling, are physical properties of different electromagnetic wave wavelength bands.

Conventional radiative cooling technology exhibits low solar reflectance or low absorption of mid-infrared light.

### SUMMARY OF THE DISCLOSURE

Therefore, the present disclosure has been made in view of the above problems, and it is an object of the present disclosure to provide a porous nanoparticle-based radiative cooling material that reflects ultraviolet light, visible light, and near-infrared light in the solar wavelength band and radiates mid-infrared light in the wavelength band of the atmospheric window and a radiative cooling device formed on the surface of the porous nanoparticle-based radiative cooling material.

It is another object of the present disclosure to provide a porous nanoparticle-based radiative cooling material obtained by imparting additive manufacturability to pore structure particles based on a multi-wavelength design for equipment application regardless of surface area and curvature.

It is still another object of the present disclosure to improve eco-friendly energy efficiency in various fields by facilitating surface application in microstructure optoelectronic systems (e.g., exposed electrodes of solar panels and flexible display elements), smart mobility, and buildings by providing a radiative cooling material with additive manufacturability.

It is still another object of the present disclosure to establish technology that implements a three-dimensional printing radiative cooling device manufactured using an additive manufacturing method by providing a radiative cooling material with additive manufacturability.

It is still another object of the present disclosure to implement and provide a radiative cooling material that is an absolute white body in the solar wavelength band by manufacturing nanoscale particles and forming a pore structure inside the particles.

It is yet another object of the present disclosure to provide a radiative cooling material capable of implementing eco-friendly cooling without energy consumption and a radiative cooling device using the same as the demand for optoelectronic systems increases rapidly with the advent of the post-corona era and interest in environmental problems caused by global warming increases.

In accordance with one aspect of the present disclosure, provided is a porous nanoparticle-based radiative cooling material including a plurality of porous nanoparticles and binder molecules, wherein the porous nanoparticles reflect incident sunlight and absorb and radiate mid-infrared light, pores are included inside dielectric particles, reflectance for the incident sunlight and mid-infrared emissivity are increased based on the pores, a laminated structure distribution is formed by the binder molecules, and the binder molecules determine the laminated structure distribution by controlling a binding force between the porous nanoparticles based on the number and size of the molecules.

When the number of the binder molecules increases, the number of attached binder molecules may increase, a repulsive force between particles may increase, and thus aggregation of the porous nanoparticles may be prevented; when the number of the binder molecules further increases, bridges may be formed by excess molecular binders, and thus aggregation of the porous nanoparticles may occur; and when a size of the attached binder molecules increases, a repulsive force between particles may increase, and thus aggregation of the porous nanoparticles may be prevented.

A mass ratio of a cosolvent and a water-soluble precursor may be proportional to a particle diameter and shell thickness of any one of the porous nanoparticles.

The porous nanoparticles may be synthesized using a cationic surfactant; and a concentration of the cationic surfactant may be proportional to a surface area of a template for forming any one of the porous nanoparticles, may be inversely proportional to a particle diameter of the porous nanoparticles, and may be proportional to a shell thickness of the porous nanoparticles.

The cationic surfactant may include at least one of cetyltrimethylammonium bromide (CTAB), cetylpyridium bromide (CPB), dodecyltrimethylammonium bromide (DTAB), and tetradecyltrimethylammonium bromide (TTAB).

The dielectric particles may be formed by synthesizing one or more of SiO₂, TiO₂, Al₂O₃, Si₃N₄, ZrO₂, CaCO₃, BaSO₄, MgO, Y₂O₃, BeO, MnO, ZnO, AlN, SiC, polydimethylsiloxane (PDMS), and polyethylene (PE).

The binder molecules may include at least one polymer material of polyacrylamide (PAM), polyvinyl alcohol (PVA), and polyvinylpyrrolidone (PVP).

In accordance with another aspect of the present disclosure, provided is a radiative cooling device including equipment exposed to incident sunlight; and a porous nanoparticle-based radiative cooling material that is laminated on a surface of the equipment and includes a plurality of porous nanoparticles and binder molecules, wherein the porous nanoparticles reflect incident sunlight based on dielectric particles and absorb and radiate mid-infrared light, pores are included inside the dielectric particles, reflectance for the incident sunlight and mid-infrared emissivity are increased based on the pores, a laminated structure distribution is formed by the binder molecules, and the binder molecules determine the laminated structure distribution by controlling a binding force between the porous nanoparticles based on the number and size of the molecules.

When the number of the binder molecules increases, the number of attached binder molecules may increase, a repulsive force between particles may increase, and thus aggregation of the porous nanoparticles may be prevented; when the number of the binder molecules further increases, bridges may be formed by excess molecular binders, and thus aggregation of the porous nanoparticles may occur; and when a size of the attached binder molecules increases, a repulsive force between particles may increase, and thus aggregation of the porous nanoparticles may be prevented.

A mass ratio of a cosolvent and a water-soluble precursor may be proportional to a particle diameter and shell thickness of any one of the porous nanoparticles.

The porous nanoparticles may be synthesized using a cationic surfactant; and a concentration of the cationic surfactant may be proportional to a surface area of a template for forming any one of the porous nanoparticles, may be inversely proportional to a particle diameter of the porous nanoparticles, and may be proportional to a shell thickness of the porous nanoparticles.

The radiative cooling material may be formed on the equipment through any one of a paste deposition process, a spray coating process, and a lithography process.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 illustrates a porous nanoparticle-based radiative cooling material according to one embodiment of the present disclosure;

FIG. 2 shows an example of applying a porous nanoparticle-based radiative cooling material according to one embodiment of the present disclosure to additive manufacturing equipment;

FIGS. 3 and 4 are diagrams explaining optical characteristics according to the presence or absence of pores in a porous nanoparticle-based radiative cooling material according to one embodiment of the present disclosure;

FIG. 5 is a diagram explaining optical characteristics according to change in diameter of porous nanoparticles in a porous nanoparticle-based radiative cooling material according to one embodiment of the present disclosure;

FIGS. 6 to 9 are diagrams and images explaining synthesis of porous nanoparticles in a porous nanoparticle-based radiative cooling material according to one embodiment of the present disclosure;

FIG. 10 is a diagram explaining reflectance according to the presence or absence of hydroxyl groups on the surface of porous nanoparticles in a porous nanoparticle-based radiative cooling material according to one embodiment of the present disclosure;

FIGS. 11 to 12C are diagrams and images explaining aggregation between porous nanoparticles in a porous nanoparticle-based radiative cooling material according to one embodiment of the present disclosure;

FIGS. 13 and 14 are images showing the lamination modeling of a porous nanoparticle-based radiative cooling material according to one embodiment of the present disclosure;

FIG. 15 includes a diagram and image explaining the technical schematic diagram and sample of a porous nanoparticle-based radiative cooling material according to one embodiment of the present disclosure; and

FIGS. 16 to 18 are diagrams explaining the radiative cooling performance of a porous nanoparticle-based radiative cooling material according to one embodiment of the present disclosure.

### DETAILED DESCRIPTION OF THE DISCLOSURE

Hereinafter, the embodiments of the present disclosure will be described in detail with reference to the drawings.

However, it should be understood that the present disclosure is not limited to the embodiments according to the concept of the present disclosure, but includes changes, equivalents, or alternatives falling within the spirit and scope of the present disclosure.

In the following description of the present disclosure, detailed description of known functions and configurations incorporated herein will be omitted when it may make the subject matter of the present disclosure unclear.

In addition, the terms used in the specification are defined in consideration of functions used in the present disclosure, and can be changed according to the intent or conventionally used methods of clients, operators, and users. Accordingly, definitions of the terms should be understood on the basis of the entire description of the present specification.

In description of the drawings, like reference numerals may be used for similar elements.

The singular expressions in the present specification may encompass plural expressions unless clearly specified otherwise in context.

In this specification, expressions such as “A or B” and “at least one of A and/or B” may include all possible combinations of the items listed together.

Expressions such as “first” and “second” may be used to qualify the elements irrespective of order or importance, and are used to distinguish one element from another and do not limit the elements.

It will be understood that when an element (e.g., first) is referred to as being “connected to” or “coupled to” another element (e.g., second), the first element may be directly connected to the second element or may be connected to the second element via an intervening element (e.g., third).

As used herein, “configured to” may be used interchangeably with, for example, “suitable for”, “ability to”, “changed to”, “made to”, “capable of”, or “designed to” in terms of hardware or software.

In some situations, the expression “device configured to” may mean that the device “may do ˜” with other devices or components.

For example, in the sentence “processor configured to perform A, B, and C”, the processor may refer to a general purpose processor (e.g., CPU or application processor) capable of performing corresponding operation by running a dedicated processor (e.g., embedded processor) for performing the corresponding operation, or one or more software programs stored in a memory device.

In addition, the expression “or” means “inclusive or” rather than “exclusive or”.

That is, unless mentioned otherwise or clearly inferred from context, the expression “x uses a or b” means any one of natural inclusive permutations.

Terms, such as “unit” or “module”, etc., should be understood as a unit that processes at least one function or operation and that may be embodied in a hardware manner, a software manner, or a combination of the hardware manner and the software manner.

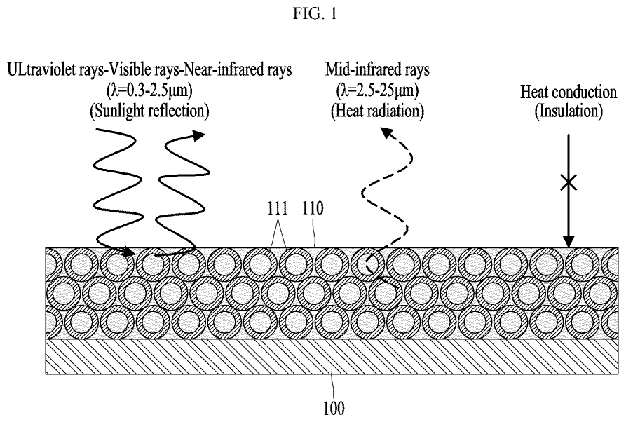

FIG. 1 illustrates a porous nanoparticle-based radiative cooling material according to one embodiment of the present disclosure.

FIG. 1 illustrates the structure of the porous nanoparticle-based radiative cooling material according to one embodiment of the present disclosure and a radiative cooling device using the radiative cooling material.

Referring to FIG. 1, a porous nanoparticle-based radiative cooling material 110 according to one embodiment of the present disclosure is formed by laminating a plurality of porous nanoparticles 111.

For example, the porous nanoparticle-based radiative cooling material 110 may be formed on an equipment surface 100 by laminating.

The porous nanoparticle-based radiative cooling material 110 according to one embodiment of the present disclosure implements heat radiation by reflecting incident sunlight consisting of ultraviolet light, visible light, and near-infrared light and absorbing and emitting mid-infrared light in the wavelength band of 8 μm to 13 μm, which corresponds to the atmospheric window. In addition, the porous nanoparticle-based radiative cooling material 110 does not conduct heat and, as an insulating material, insulates the surface of an object to which the porous nanoparticle-based radiative cooling material 110 is applied.

For example, the porous nanoparticle-based radiative cooling material 110 includes the porous nanoparticles 111 and binder molecules. Here, the binder molecules may be disposed between the porous nanoparticles 111.

For example, the porous nanoparticle-based radiative cooling material 110 includes the porous nanoparticles 111 and the binder molecules.

For example, the porous nanoparticles 111 reflect incident sunlight and absorb and radiate mid-infrared light. Pores are included inside the dielectric particles.

In addition, the porous nanoparticles 111 have an increased reflectance for incident sunlight based on pores, the distribution thereof is determined by the binder molecules, and as a result, the porous nanoparticles 111 have a laminated structure.

The porous nanoparticles 111 consist of pores, which are internal empty spaces, and shells surrounding the pores.

The dielectric particles may be formed by synthesizing one or more of SiO₂, TiO₂, Al₂O₃, Si₃N₄, ZrO₂, CaCO₃, BaSO₄, MgO, Y₂O₃, BeO, MnO, ZnO, AlN, SiC, polydimethylsiloxane (PDMS), and polyethylene (PE).

The porous nanoparticles 111 reflect incident sunlight and absorb and radiate mid-infrared light. Pores are included inside the dielectric particles, and reflectance for incident sunlight and mid-infrared emissivity are increased based on the pores.

In addition, the porous nanoparticles 111 have a laminated structure distribution by the binder molecules.

For example, the binder molecules determine the laminated structure distribution by controlling the binding force between a plurality of porous nanoparticles based on the number and size of the molecules.

That is, the binder molecules determine the distribution by controlling the repulsive force between the porous nanoparticles based on the molecular weight thereof.

In addition, when the number of the binder molecules increases, the number of attached binder molecules increases, and the repulsive force between particles increases. As a result, aggregation of the porous nanoparticles is prevented.

In addition, when the number of the binder molecules further increases, bridges are formed by excess molecular binders, resulting in aggregation of the porous nanoparticles.

In addition, when the size of attached binder molecules increases, the repulsive force between particles increases, thereby preventing aggregation of the porous nanoparticles.

For example, the attached binder molecules may be binder molecules that attach to branches on the surface of the porous nanoparticles.

According to one embodiment of the present disclosure, the radiative cooling material 110 acts as an absolute white body in the entire wavelength band of sunlight, from ultraviolet light to near-infrared light, and achieves a multi-wavelength design that produces a nearly black body in the atmospheric window band. For example, the white body reflects light and the black body absorbs light.

According to one embodiment of the present disclosure, the radiative cooling material 110 may be a radiative cooling material obtained by imparting additive manufacturability to multi-design-based pore structure particles for equipment application regardless of surface area and curvature.

According to one embodiment of the present disclosure, in a particle lamination structure, when a particle material has a high emissivity for the atmospheric window band, this material acts as the radiative cooling material 110.

The porous nanoparticles 111, which make up the radiative cooling material 110, are materials with a high refractive index in the entire wavelength band of sunlight, and may include SiO₂, TiO₂, Al₂O₃, Si₃N₄, ZrO₂, CaCO₃, BaSO₄, MgO, Y₂O₃, BeO, MnO, ZnO, AlN, SiC, and high molecular weight polymers such as polydimethylsiloxane (PDMS) and polyethylene (PE).

The mass ratio of a cosolvent and a water-soluble precursor is proportional to the particle diameter and shell thickness of the porous nanoparticles 111.

For example, the porous nanoparticles may have a particle diameter of 200 nm to 1,000 nm and a shell thickness of 40 nm to 200 nm.

The porous nanoparticles 111 are synthesized using a cationic surfactant.

For example, the concentration of the cationic surfactant is proportional to the surface area of a template for forming one of the porous nanoparticles.

In addition, the concentration of the cationic surfactant is inversely proportional to the particle diameter of the porous nanoparticles and is proportional to the shell thickness of the porous nanoparticles.

In the case of the radiative cooling material 110, in a photoelectron device in which a metal electrode is exposed to sunlight, such as a solar cell, a power-free heat management material is applied to the upper part in a shape that matches an electrode structure, and radiative cooling and sunlight reflection functions are given thereto, thereby improving the lifespan of the photoelectron device.

Accordingly, the present disclosure may provide a porous nanoparticle-based radiative cooling material that reflects ultraviolet light, visible light, and near-infrared light in the solar wavelength band and radiates mid-infrared light in the wavelength band of the atmospheric window and a radiative cooling device formed on the surface of the porous nanoparticle-based radiative cooling material.

In addition, the present disclosure may provide a porous nanoparticle-based radiative cooling material obtained by imparting additive manufacturability to pore structure particles based on a multi-wavelength design for equipment application regardless of surface area and curvature.

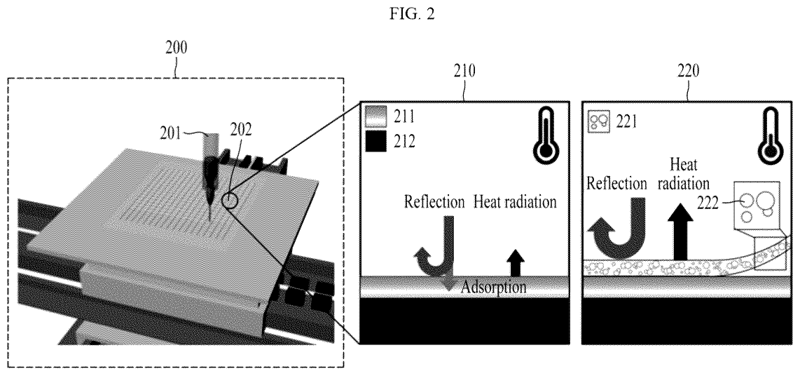

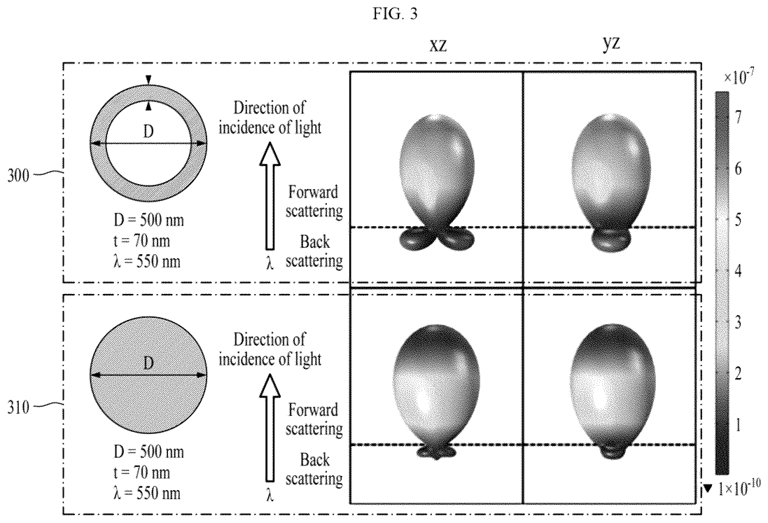

FIG. 2 is a diagram for explaining an example of applying a porous nanoparticle-based radiative cooling material according to one embodiment of the present disclosure to additive manufacturing equipment.

FIG. 2 shows an example of applying a porous nanoparticle-based radiative cooling material according to one embodiment of the present disclosure to additive manufacturing equipment.

Referring to FIG. 2, the porous nanoparticle-based radiative cooling material according to one embodiment of the present disclosure may be laminated on equipment surface 202 using lamination equipment 201 through an additive manufacturing process 200.

For example, the lamination equipment 201 may be any one of additive manufacturing equipment, three-dimensional printing equipment, lithography equipment, and spray coating equipment.

Example 210 shows a case in which a radiative cooling material is not applied to a metal electrode 211 and a solar device 212 that make up the equipment surface 202.

Example 220 shows a case where a radiative cooling material 221 is applied to the metal electrode 211 and the solar device 212 that make up the equipment surface 202.

The radiative cooling material 221 includes a plurality of porous nanoparticles 222.

The equipment surface 202 is the surface of equipment exposed to sunlight, and the radiative cooling material 221 is formed on the equipment surface 202 by laminating.

The radiative cooling material 221 may be a porous nanoparticle-based radiative cooling material including the porous nanoparticles 222 and binder molecules.

The radiative cooling material 221 may be formed on the equipment through any one of a paste deposition process, a spray coating process, and a lithography process.

The radiative cooling material 221 may be laminated on the equipment surface 202 to implement a radiative cooling device.

As shown in the thermometers in Examples 210 and 220, it can be seen that the radiative cooling material 221 reduces the temperature of the equipment surface 202 based on radiative cooling performance.

Accordingly, the present disclosure may improve eco-friendly energy efficiency in various fields by facilitating surface application in microstructure optoelectronic systems (e.g., exposed electrodes of solar panels and flexible display elements), smart mobility, and buildings by providing a radiative cooling material with additive manufacturability.

In addition, the present disclosure may establish technology that implements a three-dimensional printing radiative cooling device manufactured using an additive manufacturing method by providing a radiative cooling material with additive manufacturability.

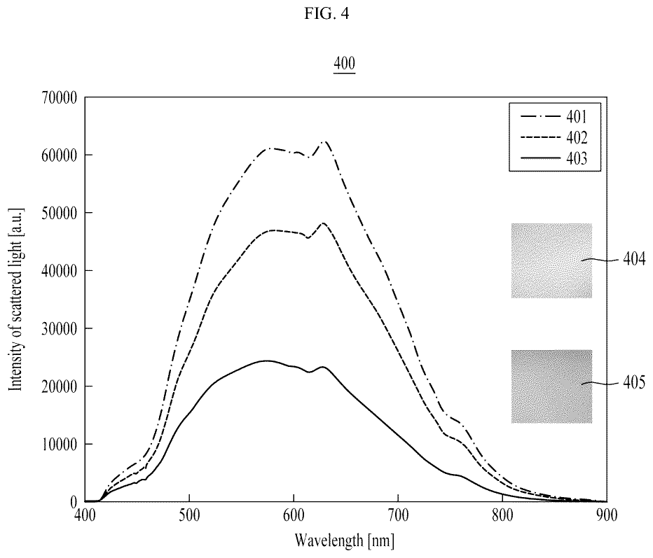

FIGS. 3 and 4 are diagrams explaining optical characteristics according to the presence or absence of pores in a porous nanoparticle-based radiative cooling material according to one embodiment of the present disclosure.

FIG. 3 illustrates the results of the finite element method (FEM) computational simulation analysis of the forward and backscattering efficiency of a single particle with or without pores in relation to the porous nanoparticles that make up the porous nanoparticle-based radiative cooling material according to one embodiment of the present disclosure.

Referring to FIG. 3, a pore structure 300 according to one embodiment of the present disclosure and a filled structure 310 in contrast to the pore structure 300 are shown.

For a single particle, as an effective scattering area increases, the intensity of scattered light increases. However, when particles are laminated, the effective scattering area of a single particle may not affect the total scattering intensity of a particle lamination structure due to the presence of adjacent particles.

The effective scattering area of a single particle affects the transmission and reflectance of the entire structure only by the ratio of the forward and back scattering intensities.

Comparing the results of computer simulation analysis of back scattering and forward scattering in the xz plane and yz plane of the pore structure 300 according to one embodiment of the present disclosure and the results of computer simulation analysis of back scattering and forward scattering in the xz plane and yz plane of the filled structure 310, it can be seen that the pore structure 300 exhibits relatively high reflectance.

FIG. 4 is a graph showing the back scattering light intensity measurement results of a particle lamination structure according to the presence or absence of pores in relation to the porous nanoparticles that make up the porous nanoparticle-based radiative cooling material according to one embodiment of the present disclosure.

Referring to FIG. 4, a graph 400 shows changes in the scattered light intensity of a light source 401, a pore structure particle lamination sample 402, and a filled structure particle lamination sample 403, and shows the surface 404 of the pore structure particle lamination sample and the surface 405 of the filled structure particle lamination sample.

The graph 400 confirms that introducing particles with pores into the nanoparticle lamination structure results in higher reflectance in the corresponding wavelength range.

The porous nanoparticle-based radiative cooling material according to one embodiment of the present disclosure is formed in a pore structure. Even when the porous nanoparticle-based radiative cooling material is formed in a laminated structure, the radiative cooling material exhibits a higher reflectance compared with the laminated structure of the filled structure.

That is, the porous nanoparticle-based radiative cooling material may improve radiative cooling performance by reflecting ultraviolet light, visible light, and near-infrared light in the solar wavelength band.

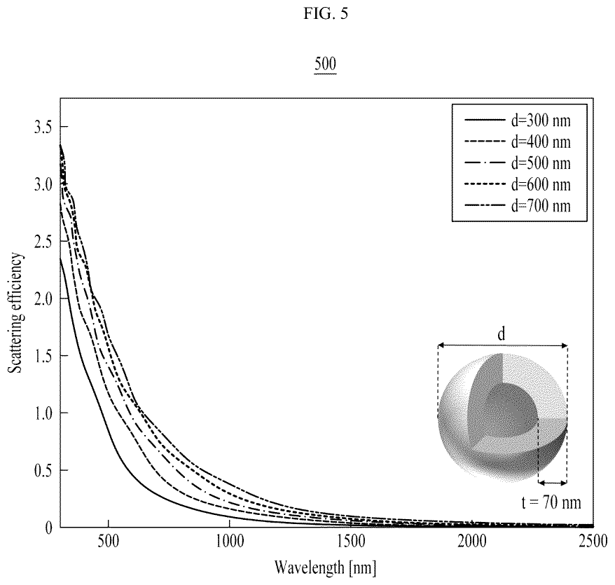

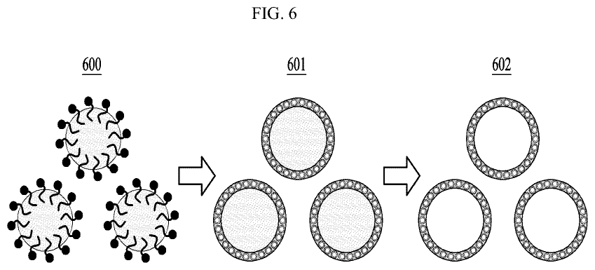

FIG. 5 is a diagram explaining optical characteristics according to change in diameter of porous nanoparticles in a porous nanoparticle-based radiative cooling material according to one embodiment of the present disclosure.

FIG. 5 shows Finite-Difference Time-Domain (FDTD) computational simulation analysis results about changes in scattering efficiency depending on the diameter of porous nanoparticles in the porous nanoparticle-based radiative cooling material according to one embodiment of the present disclosure.

Referring to FIG. 5, a graph 500 shows changes in scattering efficiency in a particle diameter (d) of 300 nm to 700 nm.

The particle diameter (d) is the sum of the diameters of a pore and nanoparticle and may correspond to the diameter of the porous nanoparticle.

The graph 500 shows the results of analyzing the scattering efficiency of electromagnetic waves of the solar wavelength band with a diameter as a variable for pore structure silica single particles under the condition that a shell thickness (t) is fixed at 70 nm.

In the graph 500, it is confirmed that among the diameter changes from 300 nm to 700 nm, the scattering efficiency is almost saturated at a diameter of 500 nm.

When the shell thickness (t) is set to 70 nm, it can be confirmed that the nanoparticle lamination structure with a pore structure of 500 nm or more can exhibit an absolute white structure.

For example, a substance that forms the shell may be any one of SiO₂, TiO₂, Al₂O₃, Si₃N₄, ZrO₂, CaCO₃, BaSO₄, MgO, Y₂O₃, BeO, MnO, ZnO, AlN, and SiC or a mixture of two or more of SiO₂, TiO₂, Al₂O₃, Si₃N₄, ZrO₂, CaCO₃, BaSO₄, MgO, Y₂O₃, BeO, MnO, ZnO, AlN, and SiC.

For example, the absolute white structure may have a scattering efficiency high enough to display white color.

FIGS. 6 to 9 are diagrams and images explaining synthesis of porous nanoparticles in a porous nanoparticle-based radiative cooling material according to one embodiment of the present disclosure.

FIG. 6 shows a schematic diagram explaining the synthesis of porous nanoparticles included in the porous nanoparticle-based radiative cooling material according to one embodiment of the present disclosure.

According to one embodiment of the present disclosure, the porous nanoparticles may be synthesized using a sol-gel/emulsion synthesis technique.

Referring to FIG. 6, according to the porous nanoparticle synthesis according to one embodiment of the present disclosure, in step 601, a micelle structure is formed.

In a solution, the micelle structure with hydrophobic tails on the inside and hydrophilic heads on the outside is formed by a cationic surfactant.

According to the porous nanoparticle synthesis according to one embodiment of the present disclosure, in step 602, interfacial condensation reaction is performed.

Inside the structural interface, water and tetraethyl orthosilicate (TEOS) react to form siloxane bonds.

The formation of siloxane bonds serves to place hydrophobic substances inside the structure, place hydrophilic reagents outside the structure, and separate reagents of different properties.

According to the porous nanoparticle synthesis according to one embodiment of the present disclosure, in step 603, pore structure particles are formed.

Porous pore structure silica particles are synthesized, and during this process, a structural interface lowers a reaction energy barrier by increasing a local reagent concentration, which has the advantage of enabling room temperature synthesis under ammonia catalyst conditions. Here, the porous pore structure silica particles may be pore structure nanoparticles.

In addition, by controlling various variables in this process, a practitioner forming a radiative cooling material may synthesize particles of desired specifications.

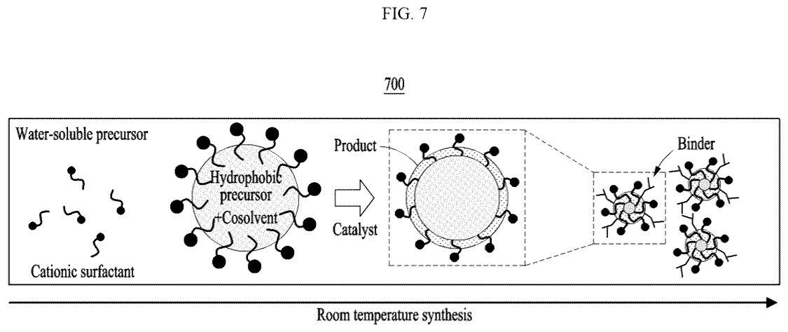

FIG. 7 shows a schematic diagram explaining the synthesis of porous nanoparticles with additive manufacturability in the porous nanoparticle-based radiative cooling material according to one embodiment of the present disclosure.

Referring to FIG. 7, in the synthesis 700 of porous nanoparticles with additive manufacturability according to one embodiment of the present disclosure, binder molecules are attached to the surface to impart additive manufacturability to the porous nanoparticle-based radiative cooling material according to one embodiment of the present disclosure.

Binder molecules are bonding materials that limit the degree of freedom between particles and provide structural stability to the final molding result.

For example, the binder molecule is at least one polymer material of polyacrylamide (PAM), polyvinyl alcohol (PVA), and polyvinylpyrrolidone (PVP), preferably PVP.

The binder molecules are added at the beginning of the synthesis process to synthesize porous nanoparticles with binder surface functional groups.

The synthesis 700 of porous nanoparticles with additive manufacturability is performed in an environment combining a water-soluble precursor and a cosolvent, and a hydrophobic precursor and a cosolvent are combined based on a cationic surfactant.

In addition, in the synthesis 700 of porous nanoparticles with additive manufacturability, porous nanoparticles are generated based on the catalytic reaction of a catalyst such as NH₄OH, and the binder molecules are added at the beginning of the synthesis process and are located on the binder surface functional groups.

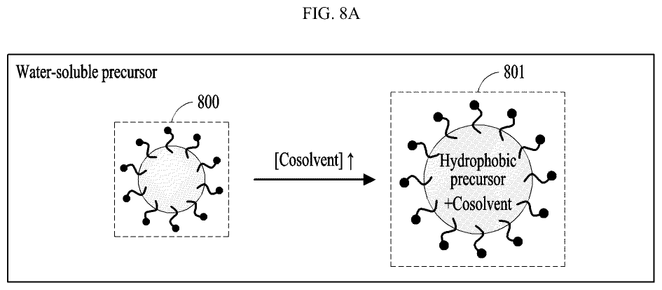

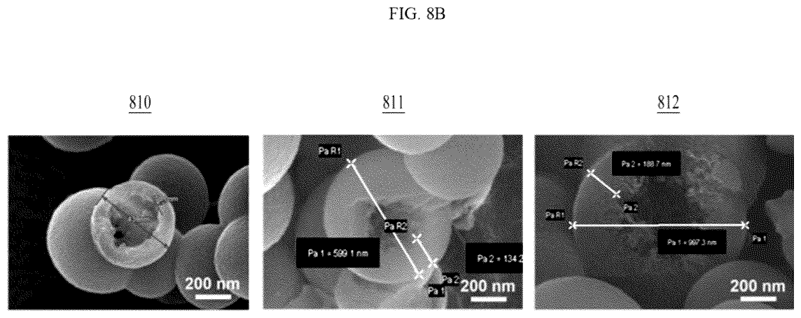

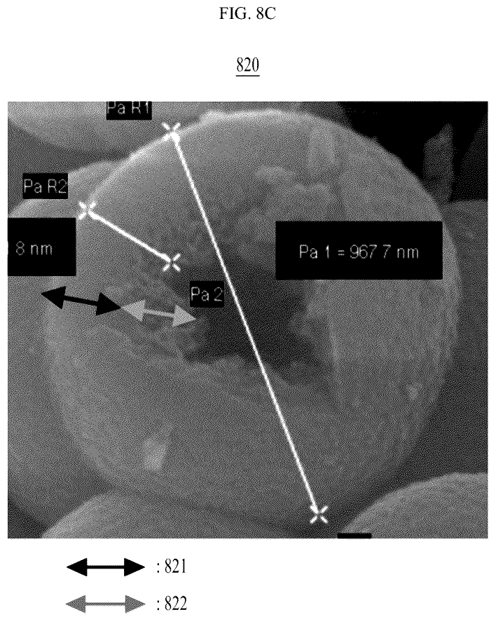

FIGS. 8A to 8C show a schematic diagram of particle diameter change as cosolvent concentration increases in relation to the synthesis of porous nanoparticles in the porous nanoparticle-based radiative cooling material according to one embodiment of the present disclosure.

That is, FIGS. 8A to 8C illustrate an example in which the cosolvent determines the particle diameter and particle shell thickness in the synthesis of porous nanoparticles with additive manufacturability.

Referring to FIG. 8A, in the synthesis of porous nanoparticles with additive manufacturability according to one embodiment of the present disclosure, a case in which the amount of the cosolvent increases is exemplified. The diameter of a particle 800 before the amount of the cosolvent is increased is shown, and the diameter of a particle 801 after the amount of the cosolvent is increased is shown.

The ratio of a cosolvent, such as an alcohol, and a hydrophilic precursor, such as deionized water, determines a particle diameter and a shell thickness.

When the amount of the cosolvent increases, the volume of an oil phase increases and the diameter of the micelle structure increases. Since the micelle structure acts as a template for synthesis, the diameter of the final synthesized particle also increases.

When the amount of the cosolvent increases, the dielectric constant of the entire synthetic solution decreases, which reduces the polarization of molecules in the solution and reduces electrical interaction between molecules. Accordingly, the penetration rate of reagents present in the aqueous phase during synthesis into the micelle increases.

As a result, the high synthesis rate causes the accumulation of particle layers, increasing both particle diameter and shell thickness.

Referring to FIG. 8B, an image 810, an image 811, and an image 812 are electron microscope images showing changes in particle diameter according to the volume ratio of ethanol and deionized water.

The image 810 shows a case where the volume ratio of ethanol and deionized water is 0.6, the image 811 shows a case where the volume ratio of ethanol and deionized water is 0.65, and the image 812 shows a case where the volume ratio of ethanol and deionized water is 0.7.

The particle diameter is proportional to the ratio of ethanol and deionized water and inversely proportional to the cationic surfactant.

When the ratio of ethanol and deionized water increases from 0.47 to 0.6, the particle diameter may increase from 210 nm to 720 nm.

In addition, when the cationic surfactant increases from 5 mM to 10 mM, the particle diameter may decrease from 400 nm to 210 nm.

In addition, when the cationic surfactant is not used and only ethanol and deionized water are used, the shell density decreases and the particle diameter is determined.

For example, when the ratio of ethanol and deionized water increases from 0.6 to 0.8, the particle diameter may increase from 500 nm to 1,000 nm.

The shell thickness is proportional to the ratio of ethanol to deionized water and the cationic surfactant.

For example, when the cationic surfactant increases from 5 mM to 10 mM, the shell thickness may increase from 70 nm to 140 nm.

In addition, when the ratio of ethanol and deionized water increases from 0.6 to 0.8, the shell thickness may increase from 70 nm to 230 nm.

Conditions for obtaining uniform particle diameter distribution may be 0.065 wt % of the binder molecules and a molecular weight (MW) of 55,000.

In addition, an increase in the diameter of the micelle structure is an increase in the diameter of the formed particles, and the diameter of the micelle structure and the diameter of the formed particles are proportional.

The mass ratio of the cosolvent and the water-soluble precursor is proportional to the diameter. When the mass ratio of the cosolvent and the water-soluble precursor is 0.47 to 0.8, the diameter may be 200 nm to 1,000 nm.

That is, the ratio of ethanol and deionized water and the dielectric constant are inversely proportional to the polarization degree of particles in the solution, and the penetration rate inside the pore is proportional.

This may be confirmed based on Equation 1 below.

D=ε₀E+P=ε₀εᵣE [Equation 1]

In Equation 1, D may represent an electric flux density, ε0 may represent a dielectric constant in vacuum, E may represent an external electric field, P may represent a polarization degree, and εr may represent a dielectric constant.

Referring to FIG. 8C, an image 820 shows a dense part 821 and a sparse part 822 related to pore formation in the image 811.

The reaction rate within a pore and increase in shell thickness and pore diameter and shell density are inversely proportional.

That is, when the reaction rate within a pore increases, the shell thickness increases, and the pore diameter and shell density decrease.

The diameter and shell thickness according to the ratio of ethanol and deionized water may be summarized in Table 1 below.

TABLE 1

| Ratio | 0.60 | 0.65 | 0.70 | 0.75 | 0.80 |
|---|---|---|---|---|---|
| Diameter (nm) | 438 | 599.1 | 997.3 | 819.5 | 967.7 |
| Thickness (nm) | 70.0 | 134.2 | 188.7 | 276.0 | 231.08 |

To maximize the difference in refractive index, the maximum density and minimum shell thickness conditions must be satisfied, and the ratio of ethanol and deionized water may correspond to 0.6.

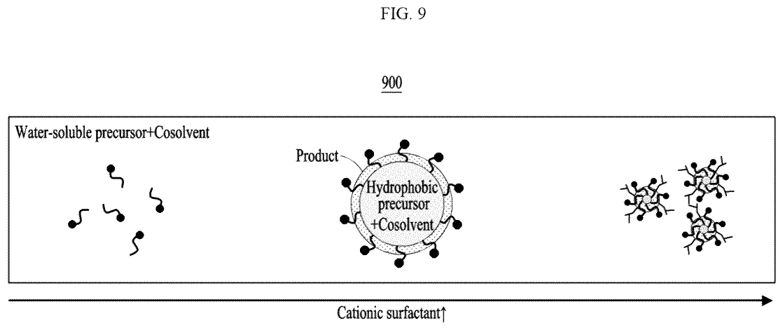

FIG. 9 is a schematic diagram showing changes in the particle diameter and shell thickness depending on the concentration of a cationic surfactant in relation to the synthesis of porous nanoparticles in the porous nanoparticle-based radiative cooling material according to one embodiment of the present disclosure.

Referring to FIG. 9, synthesis 900 of porous nanoparticles with additive manufacturability according to one embodiment of the present disclosure shows that the concentration of the cationic surfactant also changes the particle diameter and shell thickness simultaneously.

For example, the cationic surfactant includes at least one of cetyltrimethylammonium bromide (CTAB), cetylpyridium bromide (CPB), dodecyltrimethylammonium bromide (DTAB), and tetradecyltrimethylammonium bromide (TTAB).

When the concentration of the cationic surfactant increases, a hydrolysis reaction is promoted due to an increase in the surface area of a reaction interface, a synthesis rate increases, and the thickness of the resulting shells increases compared to the same reaction time.

In addition, in a situation where there is no increase in the cosolvent, when the surfactant concentration decreases, the micelle surface area compared to an oil phase volume decreases, and the diameter of the micelle increases.

Accordingly, when the cationic surfactant concentration decreases, a decrease in shell thickness and an increase in particle diameter may occur simultaneously.

When the micelle surface area increases, the particle diameter decreases as the surface area per volume increases.

In addition, when the hydrolysis reaction rate of TEOS increases, the shell thickness increases.

For example, when the concentration of the cationic surfactant is 5 mM to 10 mM, the shell thickness may be 70 nm to 140 nm, and the diameter may be 500 nm to 400 nm.

When the concentration of the cationic surfactant is 5 mM or less, a micelle structure is not formed and no particles are formed.

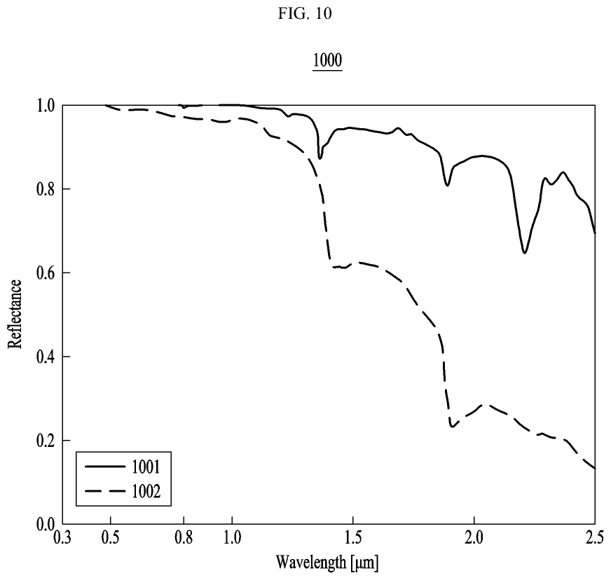

FIG. 10 is a diagram explaining reflectance according to the presence or absence of hydroxyl groups on the surface of porous nanoparticles in a porous nanoparticle-based radiative cooling material according to one embodiment of the present disclosure.

FIG. 10 shows the results of measuring the reflectance of near-infrared light before and after removal of hydroxyl groups on the surface of the particles to confirm the relationship between hydroxyl groups on the surface of porous nanoparticles and the reflectance of near-infrared light in the porous nanoparticle-based radiative cooling material according to one embodiment of the present disclosure.

Referring to FIG. 10, a graph 1000 shows the results of measuring the reflectance of near-infrared light before and after removal of the hydroxyl groups. A graph line 1001 shows after removal of the hydroxyl groups, and a graph line 1002 shows before removal of the hydroxyl groups.

On the surface of silica, there are hydroxyl groups with a hydrogen atom removed. Since the hydroxyl groups have an electric charge, the hydroxyl groups attract water molecules in the air and adsorb the water molecules to the surface.

Hydroxyl groups present on the particle surface and water molecules cause absorption of near-infrared light corresponding to a wavelength band of 1,100 nm to 1,550 nm, resulting in solar reflectance loss.

In a graph line 801 showing that silica particle pellets with a filled structure were annealed under 800° C. conditions, it can be seen that the reflectance of near-infrared light decreases after removing the hydroxyl groups on the particle surface compared to the pellet before treatment.

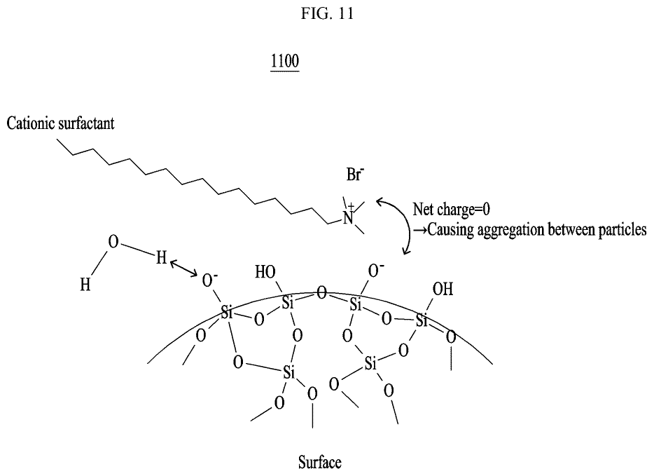

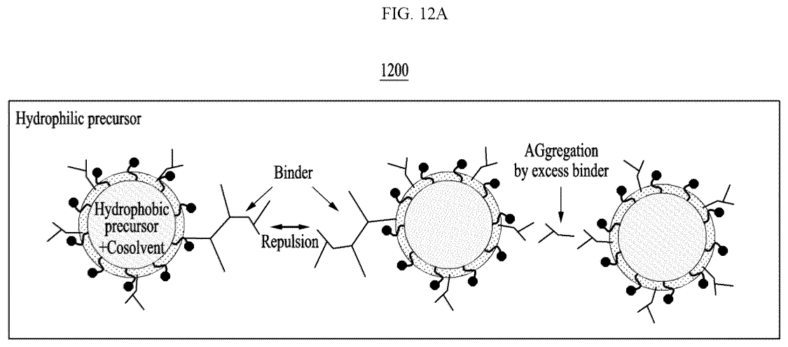

FIGS. 11 to 12C are diagrams and images explaining aggregation between porous nanoparticles in a porous nanoparticle-based radiative cooling material according to one embodiment of the present disclosure.

FIG. 11 shows a schematic diagram of surface moisture adsorption and inter-particle aggregation induced by cationic surfactant molecules during the production of porous nanoparticles in the porous nanoparticle-based radiative cooling material according to one embodiment of the present disclosure.

Referring to FIG. 11, a schematic diagram 1100 shows the problem presented in FIG. 10 by preventing the absorption of near-infrared light by water molecules by canceling out the charge of the hydroxyl groups with the cationic surfactant molecules included in the synthesis process.

However, the interparticle repulsive force caused by the existing hydroxyl groups on the silica surface is lost due to the cationic surfactant molecules for the reasons described above.

This results in the disruption of homogeneous particle size distribution, and homogeneity of particle size distribution is a very important condition for achieving a close-packed particle lamination structure.

When synthesizing pure single particles with uniform particle size distribution, that is, without aggregation, the particles are naturally laminated in a close-packed structure during the mixing and drying application process, so aggregation reaction between particles must be prevented.

FIG. 12A is a schematic diagram showing the uniformization of particle diameter distribution by binder molecules on the particle surface during the production of porous nanoparticles in the porous nanoparticle-based radiative cooling material according to one embodiment of the present disclosure.

Referring to FIG. 12A, a schematic diagram 1200 shows that the binder molecules are attached to hydroxyl groups on the particle surface by adding the binder molecules at the beginning of the synthesis reaction, and the attached binder molecules prevent aggregation of particles by the repulsive force between the binder molecules.

As the molecular weight of the input binder molecules increases, the repulsive force between branches and particles of increased size may increase.

It is important to find the appropriate concentration of binder molecules. When the concentration of binder molecules is too low, the number of attached particles decreases and sufficient repulsive force is not generated. When the concentration of binder molecules is too high, excess binder molecules induce connection between binder molecules attached to the surface, thereby promoting aggregation between particles.

FIGS. 12B and 12C shows electron microscope images related to uniformization of particle diameter distribution by binder molecules on the particle surface during the production of porous nanoparticles in the porous nanoparticle-based radiative cooling material according to one embodiment of the present disclosure.

Referring to FIG. 12B, an image 1210 shows a case where 25 mg of PVP with a molecular weight of 55,000 is administered, and an image 1211 shows a case where 50 mg of PVP with a molecular weight of 55,000 is administered.

Referring to FIG. 12C, an image 1220 shows a case where 25 mg of PVP with a molecular weight of 55,000 is administered, and an image 1221 shows a case where 25 mg of PVP with a molecular weight of 10,000 is administered.

Regarding the binder molecules, relatively uniform distribution may be obtained when 25 mg of PVP with a molecular weight of 55,000 is administered.

As the number of attached binder molecules increases, the repulsive force between particles increases and the binding force (aggregation) decreases.

When excess binder molecules occur in relation to the binder molecules, a bridge is formed and binding force increases.

As the molecular weight increases, the size of the attached binder molecules increases, and the binding force decreases as the repulsive force between particles increases.

Preferably, the optimal conditions for the binder molecules may be a molecular weight of 55,000 and 0.065 wt % based on the total solution mass.

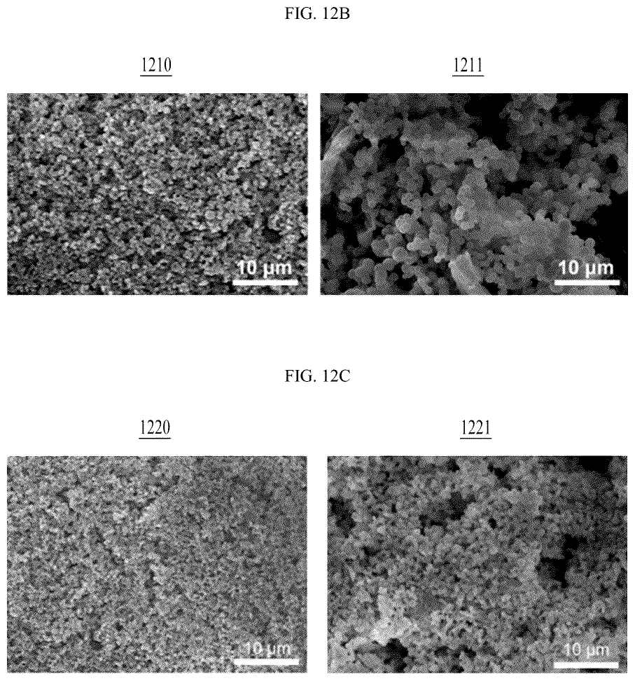

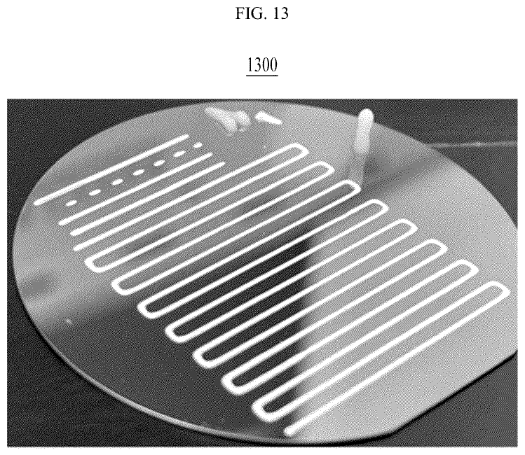

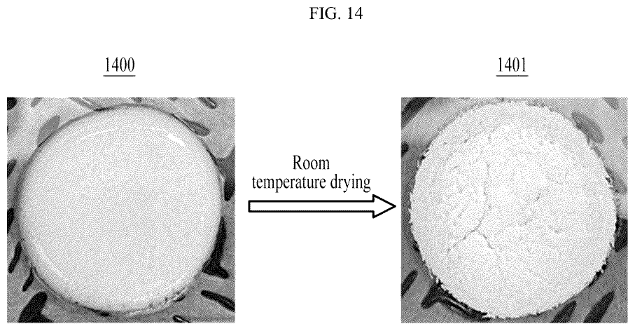

FIGS. 13 and 14 are images showing the lamination modeling of a porous nanoparticle-based radiative cooling material according to one embodiment of the present disclosure.

FIG. 13 illustrates the results of the fused lamination modeling of porous nanoparticles for additive manufacturing in relation to lamination modeling of the porous nanoparticle-based radiative cooling material according to one embodiment of the present disclosure.

Referring to FIG. 13, regarding a sample of the porous nanoparticle-based radiative cooling material, cracks inevitably cause a decrease in solar reflectance, which increases sunlight absorption of the underlying cooling target surface and induces heating.

Accordingly, to produce a sample with maximized radiative cooling performance, it is important to achieve a smooth surface by uniformly applying the produced particles.

The present disclosure may show a porous nanoparticles fusion lamination modeling result 1300 as a result of using the Fused Deposition Modeling (FDM) technique among the additive manufacturing methods and implementing a molding method that does not cause cracks during the solvent drying process.

FIG. 14 illustrates a case where cracks occur due to uneven particle diameter distribution.

Referring to FIG. 14, a sample 1400 before drying and a sample 1401 after drying are illustrated.

As shown in the sample 1401 after drying, cracks on the surface of the sample 1401 after drying are due to non-uniformity of particle diameter distribution. In a non-uniform particle diameter distribution, relatively aggregated particles act as a kind of aggregation nucleus and form particle clusters during the drying process, and the spaces between these clusters may become cracks.

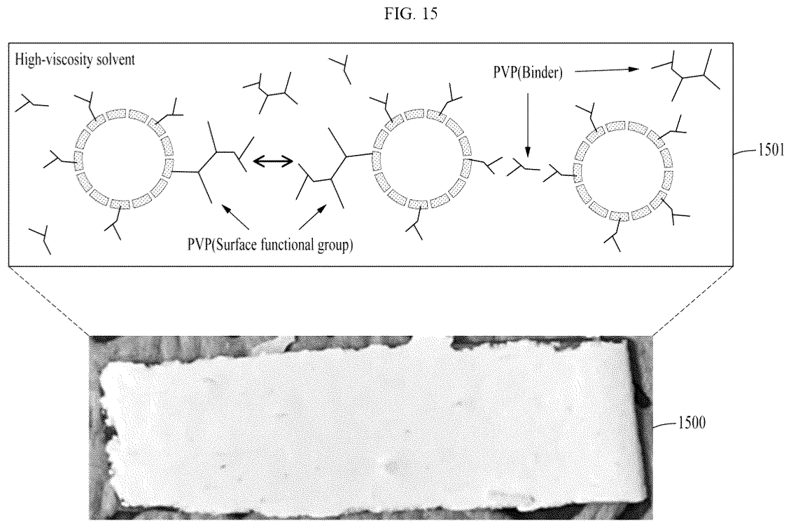

FIG. 15 includes a diagram and image explaining the technical schematic diagram and sample of a porous nanoparticle-based radiative cooling material according to one embodiment of the present disclosure.

FIG. 15 shows a schematic diagram of implementing the porous nanoparticle-based radiative cooling material according to one embodiment of the present disclosure as a crack-free lamination cooling material using a mixed molecular weight binder and a sample image.

Referring to FIG. 15, a schematic diagram 1501 for forming a sample paste 1500 is achieved by suppressing the binding reaction during synthesis with uniform particle diameter distribution and limiting the freedom of particle movement during the solvent drying process. Here, PVP is used as the binder, but PAM or PVA may also be used as the binder.

According to one embodiment of the present disclosure, during the manufacturing process of the paste 1500, which is a radiative cooling material, uniform particle diameter distribution without cracks is achieved by limiting the freedom of movement of particles in the solution.

The freedom of particle movement within the paste may be limited by increasing the viscosity of a solvent and adding a binder.

In the schematic diagram 1501, PVP as a binder molecule has a repulsive effect as a surface functional group, thereby preventing aggregation of porous nanoparticles.

In addition, PVP, which is an excess binder molecule, causes porous nanoparticles to aggregate with each other.

High viscosity solvents have a higher boiling point than low viscosity solvents, so a volatilization process proceeds at a slower rate.

As a result, the amount of momentum received by the particles in the solution is reduced, limiting the movement of the particles. Assuming particles receiving the same amount of momentum, the movement distance of particles in a relatively high-viscosity solution is reduced, so a high-viscosity solvent may limit the freedom of particle movement.

Preferably, in the present disclosure, a high-viscosity reagent such as ethylene glycol (EG) may be used as a solvent for the paste.

EG is a high-viscosity solvent and may be replaced with alcohol-based solvents such as propylene glycol and butylene glycol.

In addition, the content of particles may also determine viscosity, and the optimal particle content of the paste obtained in the present disclosure may be 12.36 wt % based on the total mass of the paste.

The binder molecules not only inhibit the movement of particles, but also interact with particle surface molecules to increase the attractive force between particles.

Accordingly, the shape of the additive manufacturing result is fixed, and additive manufacturability is imparted to the particles.

Based on additive manufacturability, a radiative cooling device may be implemented by laminating radiative cooling materials of various sizes from microstructure to macrostructure.

In the present disclosure, two types of binder molecules with molecular weights of 55,000 and 1,300,000 were mixed in a ratio of 1:1 and used as a binder. The input mass of the binder was 11.4 wt % based on the mass of particles in the paste to produce a crack-free sample. However, the present disclosure is not limited to the above-mentioned values.

According to the manufacturing process of the paste 1500, in the first step, particles stored in deionized water are separated by centrifugation. Here, the centrifugation process is performed at a speed of 7,000 rpm for 15 minutes.

In the second step, the particles are washed with washing water and centrifuged. Here, the centrifugation process is performed at a speed of 7,000 rpm for 15 minutes.

In the third step, the particle mass ratio between the centrifuged particles and the washing water is set to 17.5 wt %, the washing water is evaporated at room temperature, and the solvent is exchanged by adding EG.

In the fourth step, PVP having a molecular weight of 55,000 as a binder molecule is added in an amount of 6 wt % based on the amount of particles, and PVP having a molecular weight of 1,300,000 as a binder molecule is added in an amount of 6 wt % based on the amount of particles.

In the fifth step, the prepared paste is mixed at 2,000 rpm for 3 minutes, separated (deformation) at 2,200 rpm for 1 minute, and mixed at 2,000 rpm for 1 minute.

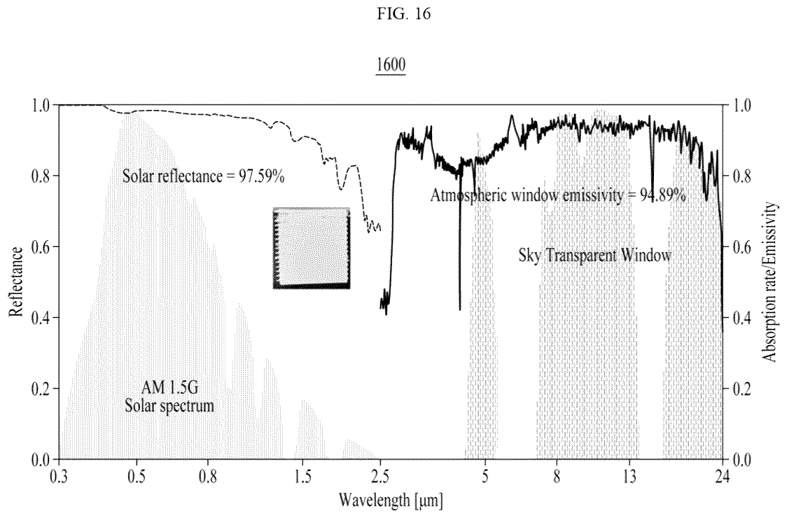

FIGS. 16 to 18 are diagrams explaining the radiative cooling performance of a porous nanoparticle-based radiative cooling material according to one embodiment of the present disclosure.

FIG. 16 shows the results of solar reflectance and mid-infrared emissivity on a radiative cooling device on which the porous nanoparticle-based radiative cooling material according to one embodiment of the present disclosure is formed.

Referring to FIG. 16, a graph 1600 shows that a radiative cooling device using the porous nanoparticle-based radiative cooling material according to one embodiment of the present disclosure achieves 97.59% solar reflectance and 94.89% emissivity for mid-infrared light corresponding to the atmospheric window.

The radiative cooling device using the porous nanoparticle-based radiative cooling material according to one embodiment of the present disclosure may implement effective radiative cooling performance based on the solar reflectance and mid-infrared emissivity described above.

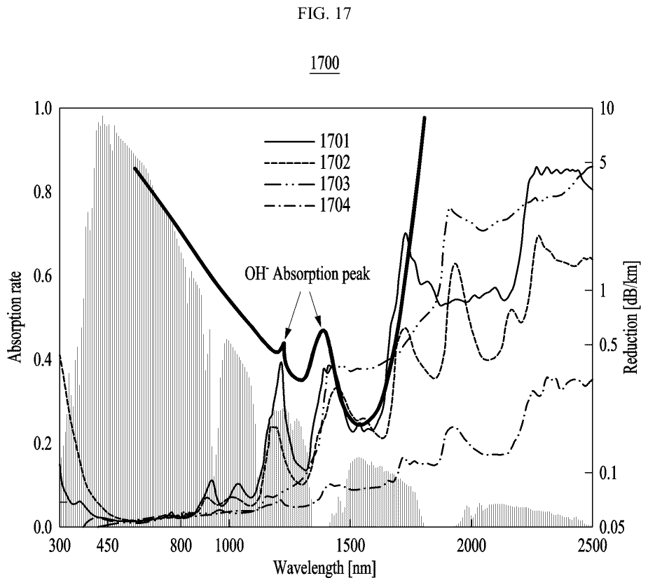

FIG. 17 shows experimental results on the absorption rate of near-infrared light of the porous nanoparticle-based radiative cooling material according to one embodiment of the present disclosure.

Referring to FIG. 17, a graph 1700 shows the results of comparing the near-infrared absorption rates of the porous nanoparticle sample and a comparison sample with a filled structure.

In the graph 1700, a graph line 1701 represents the sunlight absorption rate of a hole structure pellet (HSP) as pore structure nanoparticles corresponding to the radiative cooling material according to one embodiment of the present disclosure.

A graph line 1702 represents the sunlight absorption rate of silica with a filled structure (sealing structure pellet, SSP).

A graph line 1703 represents the sunlight absorption rate of TiO₂ pellets, and a graph line 1704 represents the sunlight absorption rate of ZrO₂ pellets.

It can be seen that the radiative cooling material according to one embodiment of the present disclosure has a relatively small absorption rate in the near-infrared light region.

The absorption rate of near-infrared light in a wavelength region of 0.8 μm to 2.5 μm decreases, which may be the result of preventing water molecules from adhering to the surface as the charge on the particle surface decreases.

Accordingly, the present disclosure may implement and provide a radiative cooling material that is an absolute white body in the solar wavelength band by manufacturing nanoscale particles and forming a pore structure inside the particles.

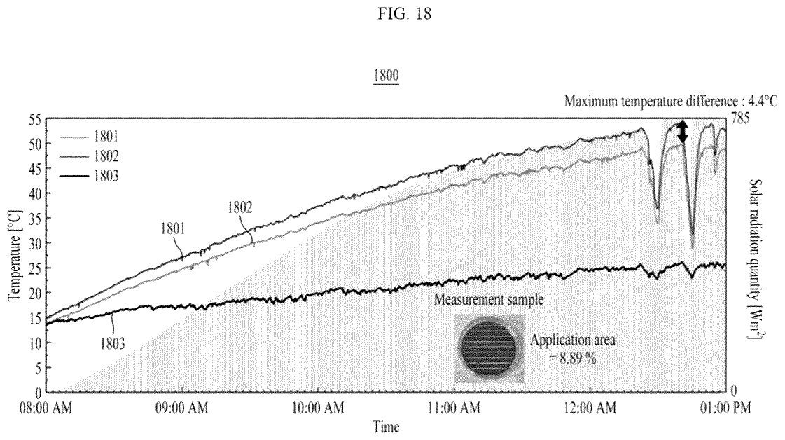

FIG. 18 shows the radiative cooling performance of a paste manufactured using the porous nanoparticle-based radiative cooling material according to one embodiment of the present disclosure.

Referring to FIG. 18, a graph 1800 shows outdoor temperature measurement results after the porous nanoparticle-based radiative cooling material was applied to the surface of a solar cell electrode simulation structure and implemented as a radiative cooling device.

In the graph 1800, a graph line 1801 represents the temperature change of the radiative cooling device according to an embodiment of the present disclosure, a graph line 1802 represents the temperature change of a silicon substrate to which the radiative cooling material according to an embodiment of the present disclosure is not applied, and a graph line 1803 represents the change in air temperature.

The radiative cooling device according to one embodiment of the present disclosure may be a sample in which a paste made of the porous nanoparticle-based radiative cooling material is applied using the additive manufacturing method to simulate the surface-exposed finger electrode structure of a solar cell on a 2-inch silicon substrate.

The area where the radiative cooling material was applied had a narrow application area of less than 8.89% of the total area, but a temperature reduction effect of more than 4.4° C. was achieved based on the maximum temperature point.

Accordingly, the present disclosure may provide a radiative cooling material capable of implementing eco-friendly cooling without energy consumption and a radiative cooling device using the same as the demand for optoelectronic systems increases rapidly with the advent of the post-corona era and interest in environmental problems caused by global warming increases.

The present disclosure can provide a porous nanoparticle-based radiative cooling material that reflects ultraviolet light, visible light, and near-infrared light in the solar wavelength band and radiates mid-infrared light in the wavelength band of the atmospheric window and a radiative cooling device formed on the surface of the porous nanoparticle-based radiative cooling material.

The present disclosure can provide a porous nanoparticle-based radiative cooling material obtained by imparting additive manufacturability to pore structure particles based on a multi-wavelength design for equipment application regardless of surface area and curvature.

The present disclosure can improve eco-friendly energy efficiency in various fields by facilitating surface application in microstructure optoelectronic systems (e.g., exposed electrodes of solar panels and flexible display elements), smart mobility, and buildings by providing a radiative cooling material with additive manufacturability.

The present disclosure can establish technology that implements a three-dimensional printing radiative cooling device manufactured using an additive manufacturing method by providing a radiative cooling material with additive manufacturability.

The present disclosure can implement and provide a radiative cooling material that is an absolute white body in the solar wavelength band by manufacturing nanoscale particles and forming a pore structure inside the particles.

The present disclosure can provide a radiative cooling material capable of implementing eco-friendly cooling without energy consumption and a radiative cooling device using the same as the demand for optoelectronic systems increases rapidly with the advent of the post-corona era and interest in environmental problems caused by global warming increases.

Although the present disclosure has been described with reference to limited embodiments and drawings, it should be understood by those skilled in the art that various changes and modifications may be made therein. For example, the described techniques may be performed in a different order than the described methods, and/or components of the described systems, structures, devices, circuits, etc., may be combined in a manner that is different from the described method, or appropriate results may be achieved even if replaced by other components or equivalents.

Therefore, other embodiments, other examples, and equivalents to the claims are within the scope of the following claims.

What is claimed is:

1. A porous nanoparticle-based radiative cooling material comprising a plurality of porous nanoparticles and binder molecules,
wherein the porous nanoparticles reflect incident sunlight and absorb and radiate mid-infrared light, pores are comprised inside dielectric particles, reflectance for the incident sunlight and mid-infrared emissivity are increased based on the pores, and a laminated structure distribution is formed by the binder molecules.

2. The porous nanoparticle-based radiative cooling material according to claim 1, wherein the binder molecules determine the laminated structure distribution by controlling a binding force between the porous nanoparticles based on the number and size of the molecules.

3. The porous nanoparticle-based radiative cooling material according to claim 2, wherein, when the number of the binder molecules increases, the number of attached binder molecules increases, a repulsive force between particles increases, and thus aggregation of the porous nanoparticles is prevented;
when the number of the binder molecules further increases, bridges are formed by excess molecular binders, and thus aggregation of the porous nanoparticles occurs; and
when a size of the attached binder molecules increases, a repulsive force between particles increases, and thus aggregation of the porous nanoparticles is prevented.

4. The porous nanoparticle-based radiative cooling material according to claim 1, wherein a mass ratio of a cosolvent and a water-soluble precursor is proportional to a particle diameter and shell thickness of any one of the porous nanoparticles.

5. The porous nanoparticle-based radiative cooling material according to claim 1, wherein the porous nanoparticles are synthesized using a cationic surfactant; and
a concentration of the cationic surfactant is proportional to a surface area of a template for forming any one of the porous nanoparticles, is inversely proportional to a particle diameter of the porous nanoparticles, and is proportional to a shell thickness of the porous nanoparticles.

6. The porous nanoparticle-based radiative cooling material according to claim 5, wherein the cationic surfactant comprises at least one of cetyltrimethylammonium bromide (CTAB), cetylpyridium bromide (CPB), dodecyltrimethylammonium bromide (DTAB), and tetradecyltrimethylammonium bromide (TTAB).

7. The porous nanoparticle-based radiative cooling material according to claim 1, wherein the dielectric particles are formed by synthesizing one or more of SiO₂, TiO₂, Al₂O₃, Si₃N₄, ZrO₂, CaCO₃, BaSO₄, MgO, Y₂O₃, BeO, MnO, ZnO, AlN, SiC, polydimethylsiloxane (PDMS), and polyethylene (PE).

8. The porous nanoparticle-based radiative cooling material according to claim 2, wherein the binder molecules comprise at least one polymer material of polyacrylamide (PAM), polyvinyl alcohol (PVA), and polyvinylpyrrolidone (PVP).

9. A radiative cooling device, comprising:
equipment exposed to sunlight; and
a porous nanoparticle-based radiative cooling material that is laminated on a surface of the equipment and comprises a plurality of porous nanoparticles and binder molecules,
wherein the porous nanoparticles reflect incident sunlight and absorb and radiate mid-infrared light, pores are comprised inside dielectric particles, reflectance for the incident sunlight and mid-infrared emissivity are increased based on the pores, and a laminated structure distribution is formed by the binder molecules.

10. The radiative cooling device according to claim 9, wherein the binder molecules determine the laminated structure distribution by controlling a binding force between the porous nanoparticles based on the number and size of the molecules.

11. The radiative cooling device according to claim 10, wherein, when the number of the binder molecules increases, the number of attached binder molecules increases, a repulsive force between particles increases, and thus aggregation of the porous nanoparticles is prevented;
when the number of the binder molecules further increases, bridges are formed by excess molecular binders, and thus aggregation of the porous nanoparticles occurs; and
when a size of the attached binder molecules increases, a repulsive force between particles increases, and thus aggregation of the porous nanoparticles is prevented.

12. The radiative cooling device according to claim 9, wherein a mass ratio of a cosolvent and a water-soluble precursor is proportional to a particle diameter and shell thickness of any one of the porous nanoparticles.

13. The radiative cooling device according to claim 9, wherein the porous nanoparticles are synthesized using a cationic surfactant; and
a concentration of the cationic surfactant is proportional to a surface area of a template for forming any one of the porous nanoparticles, is inversely proportional to a particle diameter of the porous nanoparticles, and is proportional to a shell thickness of the porous nanoparticles.

14. The radiative cooling device according to claim 9, wherein the radiative cooling material is formed on the equipment through any one of a paste deposition process, a spray coating process, and a lithography process.
